(19) United States
(12) Patent Application Publication
(10) Pub. No.: US 2020/0110745 A1
(43) Pub. Date: Apr. 9, 2020

(54) SYSTEMS AND METHODS FOR PROVIDING ANTICIPATORY SEARCH RESULTS FOR A QUERY

(71) Applicant: Rovi Guides, Inc., San Jose, CA (US)

(72) Inventors: Vikram Makam Gupta, Bangalore (IN); Nisha Thirumoorthy, Coimbatore (IN); Sukanya Agarwal, Haryana (IN)

(21) Appl. No.: 16/155,733

(22) Filed: Oct. 9, 2018

(51) Int. Cl. G06F 16/2458; G06F 16/248

(52) U.S. Cl. CPC G06F 16/2458; G06F 16/248

(57) ABSTRACT

Systems and methods are disclosed herein for providing anticipatory search results for a query. The disclosed systems and methods comprise a search engine that receives a first search query and a second query that is a follow-on alteration of the first. If the two queries match initial queries in a previously stored chain of queries, results for the final query of the previously stored chain are returned instead of results for the second query.

### BACKGROUND

The present disclosure is directed to techniques for executing search queries and, more particularly, to executing queries within a follow-on alteration query chain.

### SUMMARY

Searches often involve an iterative process of narrowing queries in a chain before arriving at a desired set of final results. This is especially true with voice-based searches. Providing the final desired results without such a chain remains technically challenging, as conventional solutions cannot predict where a chain will lead from just the original query.

Accordingly, systems and methods are disclosed herein for providing anticipatory search results for a query. The disclosed systems and methods comprise a search engine that receives a first search query and a second query that is a follow-on alteration of the first. If the two queries match initial queries in a previously stored chain of queries, results for the final query of the previously stored chain are returned instead of results for the second query.

The previous query chains are stored in a query chain database. Each chain in the database includes an original query and subsequent follow-on alterations of the query, terminating in a final follow-on alteration query. In some embodiments disclosed herein, the search chains include search terms of previous queries. The search engine attempts to match the query terms of the first and second search queries to the first and second queries of previously stored search chains. A term similarity threshold may be used for determining a match based on similarity between the terms of the first and second queries and the search chain. If the term similarity threshold is met, the chain is identified as a match.

In other embodiments disclosed below, the search chains store results of past search queries. The search engine attempts to match the results of the first and second search queries to the results in a search chain. A result similarity threshold may be used for determining a match based on similarity between the results of the first and second queries and the results of the search chain. If the result similarity threshold is met, the chain is identified as a match.

A number of techniques for determining whether a second query is a follow-on alteration are disclosed below. For example, the search engine determines whether query terms of the second search query include the query terms used in the first search query. If the query terms of the second query include the query terms used in the first search query, the second search query is identified as a follow-on alteration of the first search. In another disclosed approach, the search engine determines whether the retrieved results of the second search query are a subset of the results of the first search query. If the retrieved results are a subset, the second search query is identified as a follow-on alteration of the first search. In yet another disclosed approach, the search engine may determine the time difference between the receipt of the first and second search queries. The search engine then determines whether this time difference falls within a predefined time limit. If within the predefined time limit, the search engine determines that the second search query is a follow-on alteration.

In some embodiments, the search engine, when responding to the second search query with the retrieved results instead of the results of the second search query, sends metadata associated with the chain and the first and second search queries to the query chain database. This metadata may be used for future similarity analysis of the first and second search queries to the search chain.

### BRIEF DESCRIPTION OF THE DRAWINGS

The below and other objects and advantages of the disclosure will be apparent upon consideration of the following detailed description, taken in conjunction with the accompanying drawings, in which like reference characters refer to like parts throughout, and in which:

FIG. 1 shows an illustrative diagram of multiple voice-based search chains, in accordance with some embodiments of the disclosure;

FIG. 2 shows an illustrative data flow diagram of the search engine receiving multiple search queries and responding with retrieved results, in accordance with some embodiments of the disclosure;

FIG. 3 shows an illustrative diagram of multiple search chain data structures, in accordance with some embodiments of the disclosure;

FIG. 4 shows an illustrative system diagram of the search engine server, query chain database, and multiple client devices, in accordance with some embodiments of the disclosure;

FIG. 5 shows an illustrative block diagram of the search engine server, in accordance with some embodiments of the disclosure;

FIG. 6 is an illustrative flowchart of a process for providing anticipatory search results for a query, in accordance with some embodiments of the disclosure;

FIG. 6 is an illustrative flowchart of yet another process for providing anticipatory search results for a query, in accordance with some embodiments of the disclosure;

FIG. 7 is an illustrative flowchart of a process for matching search terms between a query within a chain of queries and the received first search query, in accordance with some embodiments of the disclosure;

FIG. 8 is an illustrative flowchart of a process for matching search terms between a second query within a chain of queries and the received second search query, in accordance with some embodiments of the disclosure;

FIG. 9 is an illustrative flowchart of a process for matching search results between a query within a chain of queries and the received first search query, in accordance with some embodiments of the disclosure;

FIG. 10 is an illustrative flowchart of a process for matching search results between a second query within a chain of queries and the received second search query, in accordance with some embodiments of the disclosure;

FIG. 11 is an illustrative flowchart of one embodiment of determining whether the second search query is a follow-on alteration of the first search query, in accordance with some embodiments of the disclosure;

FIG. 12 is an illustrative flowchart of another embodiment of determining whether the second search query is a follow-on alteration of the first search query, in accordance with some embodiments of the disclosure; and

FIG. 13 is an illustrative flowchart of yet another embodiment of determining whether the second search query is a follow-on alteration of the first search query, in accordance with some embodiments of the disclosure.

### DETAILED DESCRIPTION

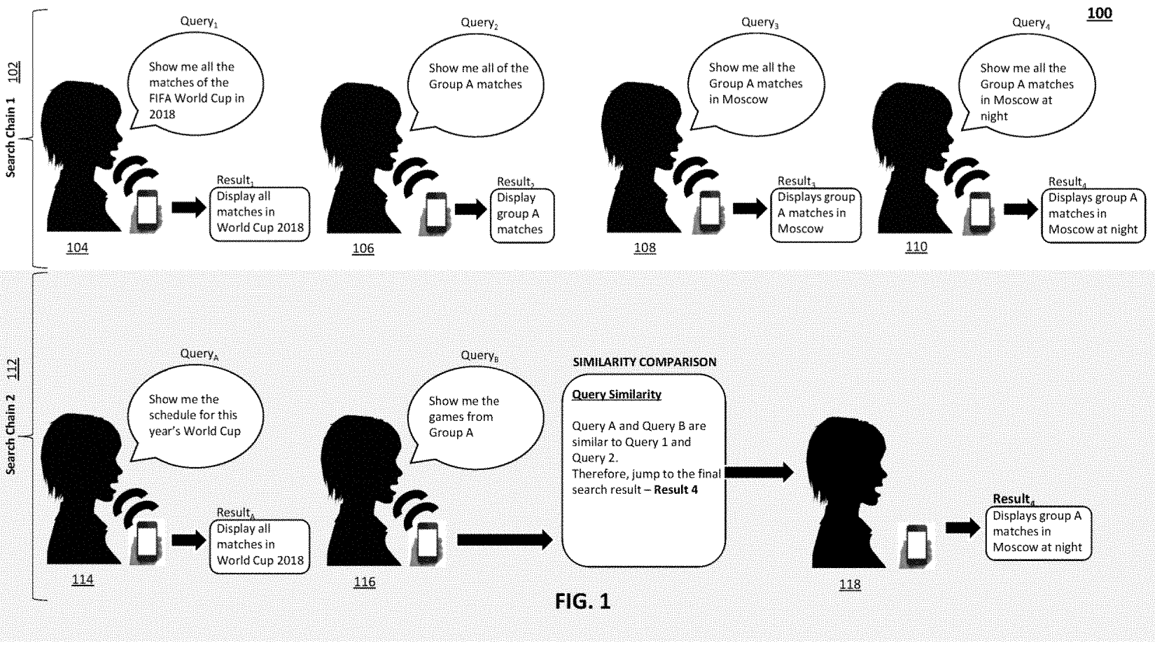

FIG. 1 shows an illustrative diagram 100 of multiple voice-based search chains, in accordance with some embodiments of the disclosure. Within a first search chain 102, a user 104 speaks to their voice assistant application on their smartphone and queries “Show me all the matches of the FIFA World Cup in 2018.” A search engine, implemented on a search engine server, receives the audio data containing the voice-based search query from the user's smartphone. The search engine processes the audio data and provides a first set of results to the first query, which display all the matches in the 2018 FIFA World Cup on the user's smartphone.

Upon examining the search results, the user wishes to narrow their search further. The user initiates a follow-up query, a second query 106, to the first query by speaking “Show me all the Group A matches.” The search engine receives the second query of audio data, processes the audio data, and provides a second set of results to the second query, which display all the matches from Group A.

The user wishes to even further narrow their search results. The user initiates a third query 108 by speaking “Show me all the Group A matches in Moscow” to their voice assistant application on their smartphone. The search engine receives the third query of audio data, processes the audio data, and provides a third set of results to the third query, which display all the matches from Group A in Moscow.

The user wishes to further narrow their search results one final time. The user initiates a fourth query 110 by speaking “Show me all the Group A matches in Moscow at night” to their voice assistant application on their smartphone. The search engine receives the fourth query of audio data, processes the audio data, and provides a fourth set of results to the fourth query, which display all the matches from Group A in Moscow at night. The search engine deems this query the end of the search chain.

Continuing from the example above, at a second time later than the end of the first search chain, the user initiates a second search chain 112. The second search chain includes a similar first query 114 to the first query of the first search chain, namely, the user says “Show me the schedule for this year's World Cup” to their voice assistant application on their smartphone. The search engine receives the audio data of the first query of the second search chain, processes the audio data, and provides the results to the first query of the second search chain, which displays all the matches in the 2018 FIFA World Cup.

The user wishes to further narrow their search results in the second search chain. The user initiates a second query 116, a follow-on query, by speaking “Show me the games from Group A” to their voice assistant application on their smartphone. The search engine searches a query chain database comprising past search queries. In this case, the search engine retrieves the queries from the first search chain. The search engine analyses the queries from the first search chain and finds a match determining that the second search query (of the second search chain) is associated as a follow-on alteration of the first search query. Thus, the search engine identifies the first search query as a match. In response, the search engine retrieves the results of the final follow-on alteration query associated with the first search chain (e.g., the results of the fourth search query) and responds to the user with these results, specifically displaying all the matches from Group A in Moscow at night 118. The search engine traversed the search chain to retrieve the results of the final query in the search chain and provide it to the user. Consequently, the user did not need to repeat the second and third voice queries in order to ascertain the results of the fourth search query.

In some embodiments, when the search engine searches the query chain database for a match for the first search query, similarity thresholds may be implemented. The search engine may determine whether the search terms of the query within the chain of queries and the search terms of the first search query exceed a term similarity threshold. The term similarity threshold may be preconfigured into the search engine server or, alternatively, it may be dynamically adjusted based on the variance in search query terms received by the search engine server. For example, a threshold may be based on the search engine conducting a statistical analysis on the variance of received search query terms. Continuing from FIG. 1, the search engine searches the database for previous queries to find a matching query that is similar or identical to the first search query. The search engine receives the query 114 “Show me the schedule for this year's World Cup” and finds an entry in the query chain database which includes the query “Show me all the matches of the FIFA World Cup in 2018” from 104. The search terms of each of these queries are analyzed by the search engine. In particular, although the word “schedule” was used in place of “matches” and “this year's World Cup” was used in place of “FIFA World Cup 2018,” the search engine identifies the query 114 as a match for the first search query 104 as it passes the term similarity threshold.

Similar to the embodiment mentioned above, the search engine may also use results of queries for matching where a result similarity threshold may be implemented. For example, the search engine may determine whether search results of the query within the chain of queries and the search results of the first search query exceed a result similarity threshold. If the result similarity threshold is exceeded, the search engine server identifies the query within the chain of queries exceeding the result similarity threshold as a match. The search engine may then, in response to finding a match, determine whether the second search query is associated by the database as a follow-on alteration. For example, continuing from FIG. 1, the search engine determines a match 104 in the query chain database that is similar to the first search query 114. The search engine now determines whether the second search query 116 (i.e., “Show me the games from Group A”) is associated as a follow-on alteration to the matching search query 104. Because the second search query 116 is a follow-on alteration, in that it modifies and narrows the search of the matching query 104, it is determined by the search engine as a follow-on alteration. Various techniques for determining whether a second query is a follow-on alteration are implemented in this disclosure. For example, one technique determining whether a second query is a follow-on alteration includes determining matching search query terms between the matching query and second search query. In another disclosed approach, the search engine determines whether the retrieved results of the second search query are a subset of the results of the first search query. In yet another disclosed approach, the search engine may determine the time difference between the receipt of the first and second search queries.

In some embodiments, the search engine receives audio data comprising the received search query. The audio data may come from any type of computer, actor, ambient noise, or environment. For example, continuing from FIG. 1, the search engine receives audio data from a user's smartphone 104. The audio data includes a search query. The search engine may then determine, using a speech-to-text technique, one or more keywords from the received search query within the received audio data. For example, continuing from FIG. 1, after receiving the audio data, the search engine converts the audio data into text format using a speech-to-text technique. The text reads “Show me all the matches of the FIFA World Cup in 2018” 104.

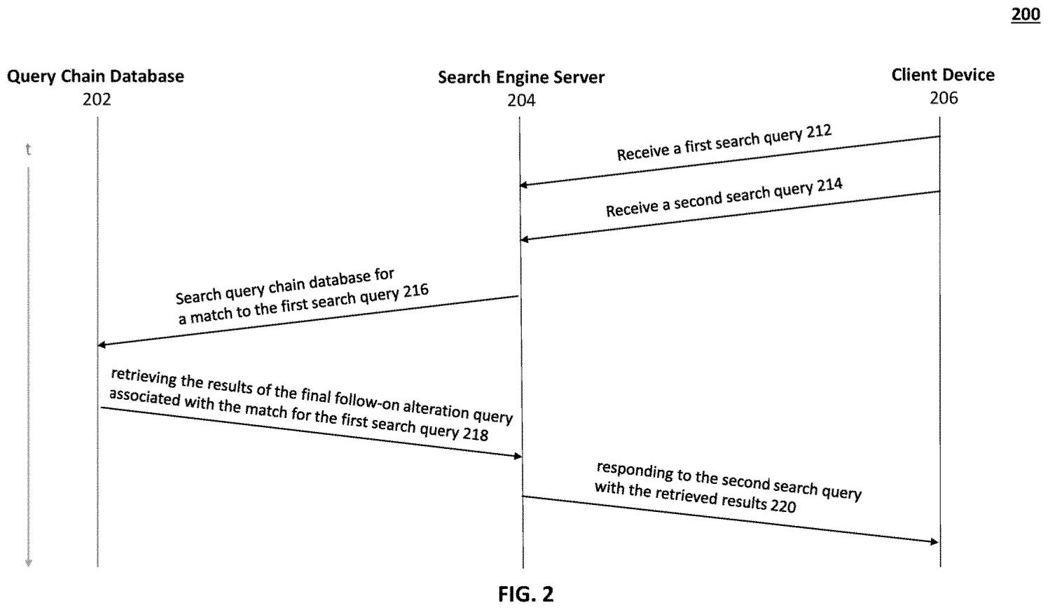

FIG. 2 shows an illustrative data flow diagram of the system receiving multiple search queries and responding with retrieved results in accordance with some embodiments of the disclosure. The system 200 may include a query chain database 202, search engine server 204, and client device 206. The search engine server may receive a first search query 212 from the client device. The search engine server may subsequently receive a second search query 214. The search engine server then searches the query chain database for a match to the first search query 216. The search engine server may retrieve the results of the final follow-on alteration query associated with the match for the first search query 218. Subsequent to retrieving the results, the search engine server may respond to the second search query with the retrieved results 220.

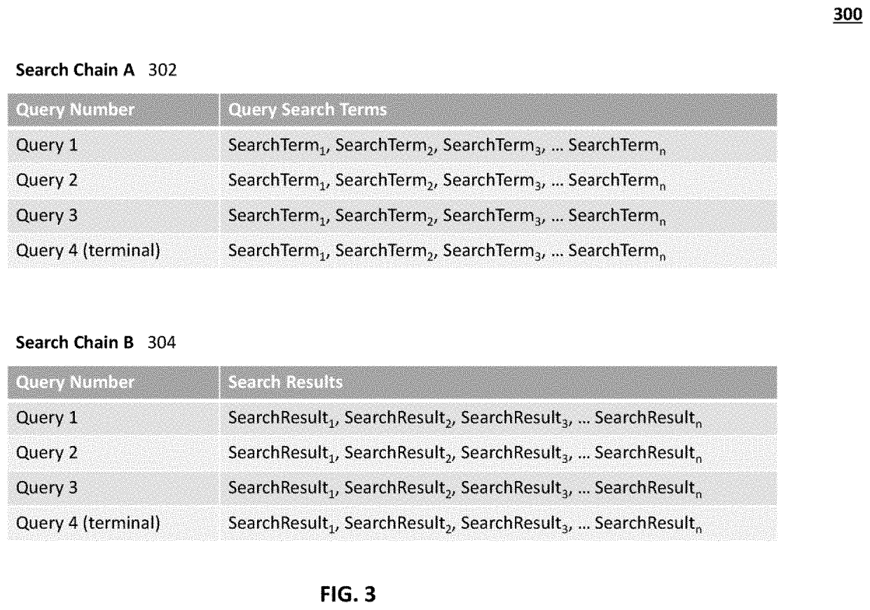

FIG. 3 shows an illustrative diagram of multiple search chain data structures 300 in accordance with some embodiments of the disclosure. An example of a search chain is shown in search chain A 302. Search chain A includes an original query (e.g., Query 1) and subsequent follow-on alterations of the query (e.g., Query 2, Query 3, and Query 4). Search chain A also has a terminal final follow-on alteration query (e.g., Query 4). Each query within the search chain includes one or more search terms. Query 1 has search terms numbered 1 to n (with ‘n’ representing the total number of search terms within the query). For example, continuing from FIG. 1, the first query of the user 104 includes the search terms “show,” “me,” “all,” “the,” “matches,” “of,” “the,” “FIFA,” “World Cup,” “in,” and “2018.” In a similar fashion, search chain B 304 includes a structure where each query within the search chain includes one or more search results. Query 1 has search terms numbered 1 to n (with ‘n’ representing the total number of search results within the query). For example, the results of query 104 would include the total list of matches in the 2018 FIFA World Cup.

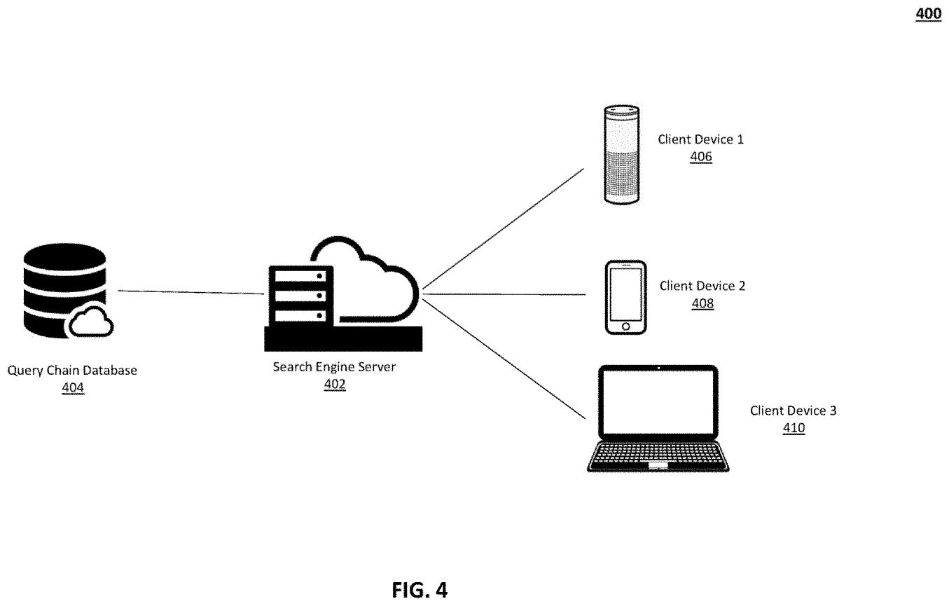

FIG. 4 shows an illustrative system diagram including the search engine server, query chain database, and multiple client devices in accordance with some embodiments of the disclosure. The system 400 includes a search engine server which interfaces with any number of client devices 406, 408, and 410 to receive search queries. The search engine server 402 further interfaces with a query chain database 404 to retrieve stored search queries and other search query-related information which may be stored at the query chain database.

The client devices 406, 408, and 410 may be any type of device that is capable of receiving search queries. For example, client device 406 is a voice assistant for a home that receives voice commands. In another example, client device 408 may be a smartphone, which may receive textual input, voice commands to a voice assistant application, and visual search queries. In yet another example, client device 410 may be a laptop, which may receive textual input, voice commands to a voice assistant application, and visual search queries.

The search engine server 402 sends search queries to the query chain database 404 for storage and classification. For example, a first query is sent to the query chain database, while all subsequent queries, if deemed follow-on alterations, are sent to the query chain database for storage as follow-on alterations. The query chain database stores the initial query and all follow-on alterations as search chains.

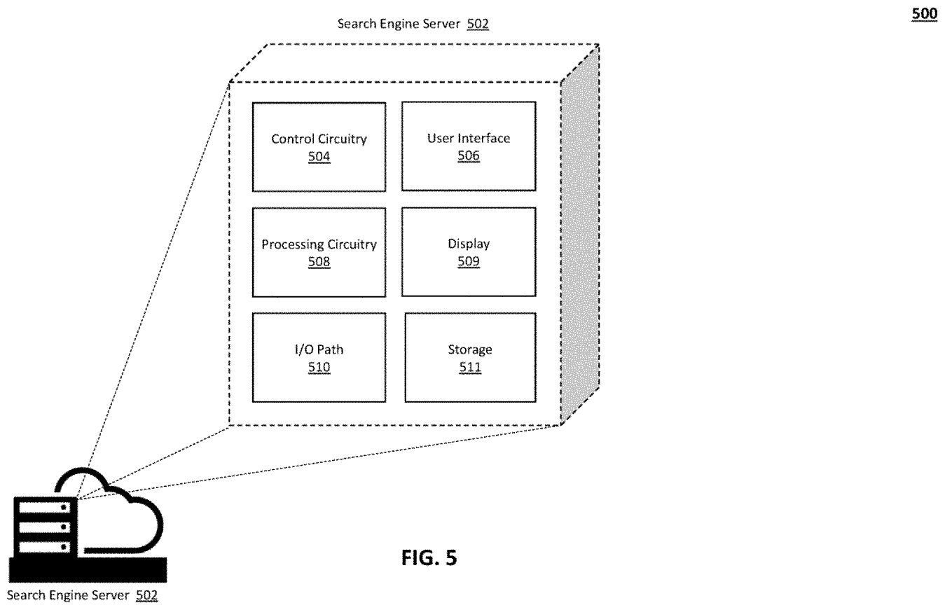

FIG. 5 shows an illustrative block diagram of the search engine server 502 in accordance with some embodiments of the disclosure. In some embodiments, the search engine server may be communicatively connected to a user interface 506. In some embodiments, the search engine server may include processing circuitry, control circuitry, and storage (e.g., RAM, ROM, hard disk, removable disk, etc.). The search engine server may include an input/output path 510. I/O path 510 may provide device information, or other data over a local area network (LAN) or wide area network (WAN), and/or other content and data to control circuitry 504, which includes processing circuitry 508 and storage 511. control circuitry 504 may be used to send and receive commands, requests, and other suitable data using I/O path 510. I/O path 510 may connect control circuitry 504 (and specifically processing circuitry 508) to one or more communications paths.

Control circuitry 504 may be based on any suitable processing circuitry such as processing circuitry 508. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 504 executes instructions for an emulation system application stored in memory (i.e., storage 511).

Memory may be an electronic storage device provided as storage 511 which is part of control circuitry 504. As referred to herein, the phrase “electronic storage device” or “storage device” should be understood to mean any device for storing electronic data, computer software, or firmware, such as random-access memory, read-only memory, hard drives, solid state devices, quantum storage devices, or any other suitable fixed or removable storage devices, and/or any combination of the same. Nonvolatile memory may also be used (e.g., to launch a boot-up routine and other instructions).

A user may send instructions to control circuitry 504 using user interface 506. User input interface 506 may be any suitable user interface, such as a remote control, mouse, trackball, keypad, keyboard, touchscreen, touchpad, stylus input, joystick, voice recognition interface, or other user input interfaces. A Display 509 may be provided as a stand-alone device or integrated with other elements of each one of search engine server device 502. For example, display 509 may be a touchscreen or touch-sensitive display. In such circumstances, user input interface 506 may be integrated with or combined with display 509. Display 509 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 509 may be HDTV-capable. In some embodiments, display 509 may be a 3D display, and the interactive emulation system application and any suitable content may be displayed in 3D. A video card or graphics card may generate the output to the display 509. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 504. The video card may be integrated with the control circuitry 504.

The search engine server 502 may be coupled to communications network. Communications network may be one or more networks including the Internet, a mobile phone network, mobile voice or data network (e.g., a 4G or LTE network), cable network, public switched telephone network, or other types of communications network or combinations of communications networks. Paths may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths.

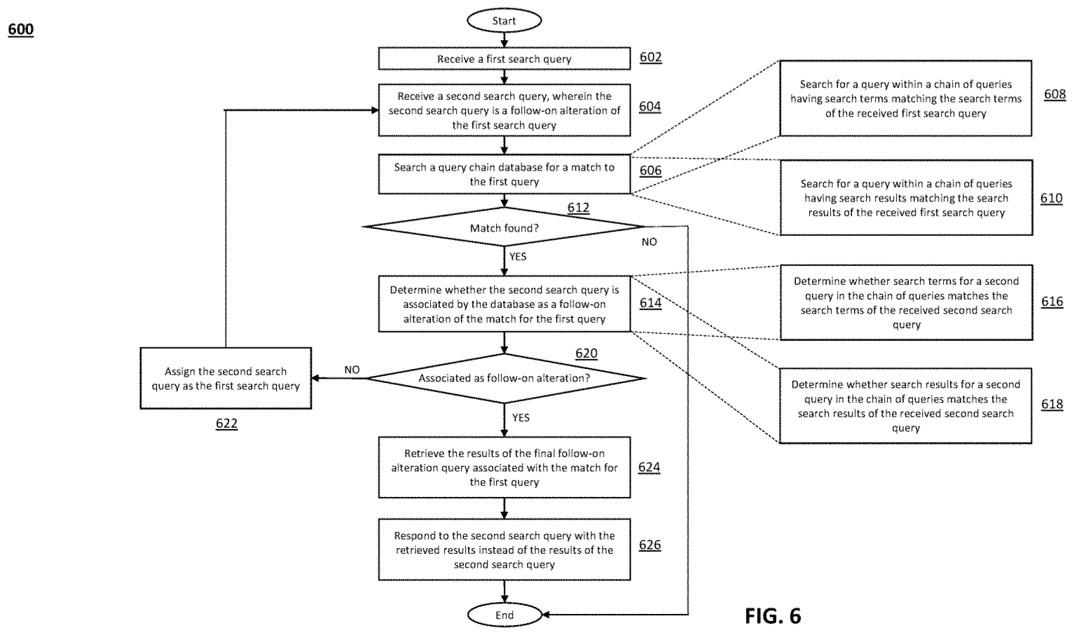

FIG. 6 is an illustrative flowchart of a process 600 for matching search terms between a query within a chain of queries and the received first search query, in accordance with some embodiments of the disclosure. Process 600, and any of the following processes, may be executed by control circuitry 504 (e.g., in a manner instructed to control circuitry 504 by the search engine server). Control circuitry 504 may be part of search engine server 502, or of a remote server separated from the search engine server by way of communication network, or distributed over a combination of both.

At 602, the search engine server, by control circuitry 504, receives a first search query. At 604, the search engine server, by control circuitry 504, receives a second search query. Any of the first and second search queries may comprise any form of data including, but not limited to, audio data, textual data, and/or data structured in a machine-readable format. The search engine server 502 may receive the first and second search queries through an I/O path 510.

At 606, the search engine server, by control circuitry 504, searches a query chain database for a match for the first search query. The query chain database associates queries that are part of a chain of queries which includes an original query and subsequent follow-on alterations of the query, and each chain of association terminates in a final follow-on alteration query. The I/O path 510 may allow the search engine server to interface with the query chain server, while processing circuitry 508 searches the query chain database for the match for the first search query. The query chain database may be implemented in a variety of configurations. In some embodiments, the query chain database 404 is communicatively connected to the search engine server through wired/wireless communication means. In other embodiments, the query chain database is a module of the search engine server 502 which is implemented in the storage 511 of the search engine server 502. If, at 612, control circuitry determines “No,” by searching for a query within a chain of queries having search results matching the search results of the received first search query, and a match was not found, the process advances to “End.”

If, at 612, control circuitry determines “Yes,” by searching for a query within a chain of queries having search results matching the search results of the received first search query, and a match was found, the process advances to 614. At 614, control circuitry 504 determines whether the second search query is associated by the query chain database as a follow-on alteration of the match for the first search query. If, at 620, control circuitry determines “No,” the second search query is not associated by the query chain database as a follow-on alteration of the match for the first search query, the process advances to 622. At 622, control circuitry 504 assigns the second search query as the first search query and the process reverts to 604.

If, at 620, control circuitry determines “Yes,” the second search query is associated by the query chain database as a follow-on alteration of the match for the first search query, the process advances to 624. At 624, control circuitry 504 retrieves the results of the final follow-on alteration query associated with the match for the first query. In some embodiments, the retrieval of the results may be from storage 511. In other embodiments, the retrieval of results may be from the query chain database 404.

At 626, the search engine server, by control circuitry 504, responds to the second search query with the retrieved results instead of the results of the second search query. Responding to the second search query may involve sending results through the I/O path 510 to a client device 406, 408, or 410.

At 608, the search engine server, by control circuitry 504, searches for a query within a chain of queries having search terms matching the search terms of the received first search query. In some embodiments, processing circuitry 508 may, in part or in whole, search for a query within a chain of queries having search terms matching the search terms of the received first search query.

At 610, the search engine server, by control circuitry 504, searches for a query within a chain of queries having search results matching the search results of the received first search query. In some embodiments, processing circuitry 508 may, in part or in whole, search for a query within a chain of queries having search results matching the search results of the received first search query.

At 616, the search engine server, by control circuitry 504, determines whether search terms for a second query in the chain of queries match the search terms of the received second search query. In some embodiments, processing circuitry 508 may, in part or in whole, determine whether search terms for a second query in the chain of queries match the search terms of the received second search query.

At 618, the search engine server, by control circuitry 504, determines whether search results for a second query in the chain of queries match the search results of the received second search query. In some embodiments, processing circuitry 508 may, in part or in whole, determine whether search results for a second query in the chain of queries match the search results of the received second search query.

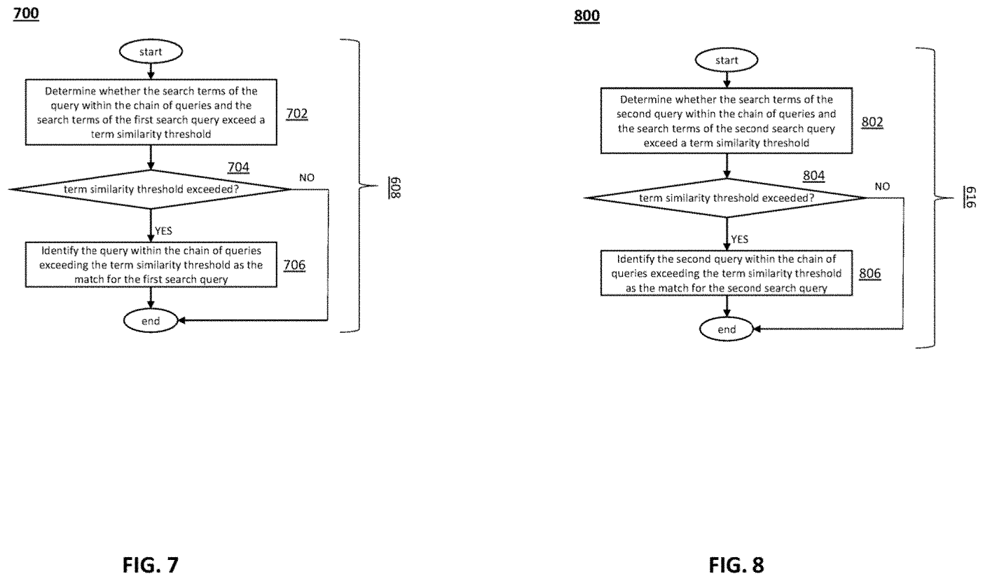

FIG. 7 is an illustrative flowchart of a process for matching search terms between a query within a chain of queries and the received first search query, in accordance with some embodiments of the disclosure. At 702, the search engine server, by control circuitry 504, determines whether the search terms of the query within the chain of queries and the search terms of the first search query exceed a term similarity threshold. In some embodiments, processing circuitry 508 may, in part or in whole, determine whether the search terms of the query within the chain of queries and the search terms of the first search query exceed a term similarity threshold. If, at 704, control circuitry determines “No,” the search terms of the query within the chain of queries and the search terms of the first search query do not exceed the term similarity threshold, the process advances to “End.”

If, at 704, control circuitry determines “Yes,” the search terms of the query within the chain of queries and the search terms of the first search query exceed the term similarity threshold, the process advances to 706. At 706, the search engine server, by control circuitry 504, identifies the query within the chain of queries exceeding the term similarity threshold as the match for the first search query.

FIG. 8 is an illustrative flowchart of a process for matching search terms between a second query within a chain of queries and the received second search query, in accordance with some embodiments of the disclosure. At 802, the search engine server, by control circuitry 504, determines whether the search terms of the second query within the chain of queries and the search terms of the second search query exceed a term similarity threshold. In some embodiments, processing circuitry 508 may, in part or in whole, determine whether the search terms of the second query within the chain of queries and the search terms of the second search query exceed a term similarity threshold. If, at 804, control circuitry determines “No,” the search terms of the second query within the chain of queries and the search terms of the second search query do not exceed the term similarity threshold, the process advances to “End.”

If, at 804, control circuitry determines “Yes,” the search terms of the second query within the chain of queries and the search terms of the second search query exceed the term similarity threshold, the process advances to 806. At 806, the search engine server, by control circuitry 504, identifies the second query within the chain of queries exceeding the term similarity threshold as the match for the second search query.

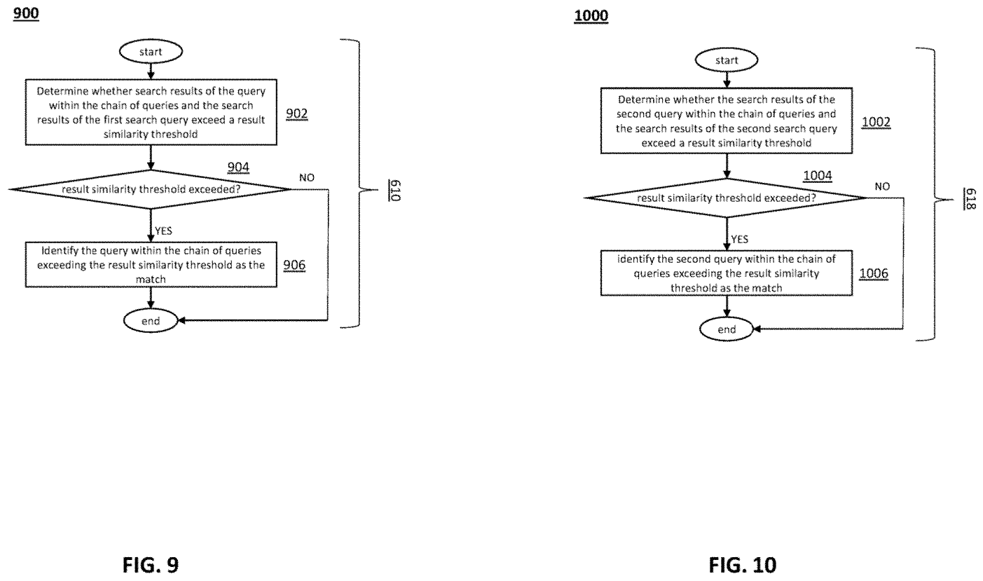

FIG. 9 is an illustrative flowchart of a process for matching search results between a query within a chain of queries and the received first search query, in accordance with some embodiments of the disclosure. At 902, the search engine server, by control circuitry 504, determines whether search results of the query within the chain of queries and the search results of the first search query exceed a result similarity threshold. In some embodiments, processing circuitry 508 may, in part or in whole, determine whether search results of the query within the chain of queries and the search results of the first search query exceed a result similarity threshold. If, at 904, control circuitry determines “No,” the search results of the query within the chain of queries and the search results of the first search query do not exceed the result similarity threshold, the process advances to “End.”

If, at 904, control circuitry determines “Yes,” the search results of the query within the chain of queries and the search results of the first search query exceed the result similarity threshold, the process advances to 906. At 906, the search engine server, by control circuitry 504, identifies the query within the chain of queries exceeding the result similarity threshold as the match.

FIG. 10 is an illustrative flowchart of a process for matching search results between a second query within a chain of queries and the received second search query, in accordance with some embodiments of the disclosure. At 1002, the search engine server, by control circuitry 504, determines whether search results of the second query within the chain of queries and the search results of the second search query exceed a result similarity threshold. In some embodiments, processing circuitry 508 may, in part or in whole, determine whether search results of the second query within the chain of queries and the search results of the second search query exceed a result similarity threshold. If, at 1004, control circuitry determines “No,” the search results of the second query within the chain of queries and the search results of the second search query do not exceed the result similarity threshold, the process advances to “End.”

If, at 1004, control circuitry determines “Yes,” the search results of the second query within the chain of queries and the search results of the second search query exceed the result similarity threshold, the process advances to 1006. At 1006, the search engine server, by control circuitry 504, identifies the second query within the chain of queries exceeding the result similarity threshold as the match.

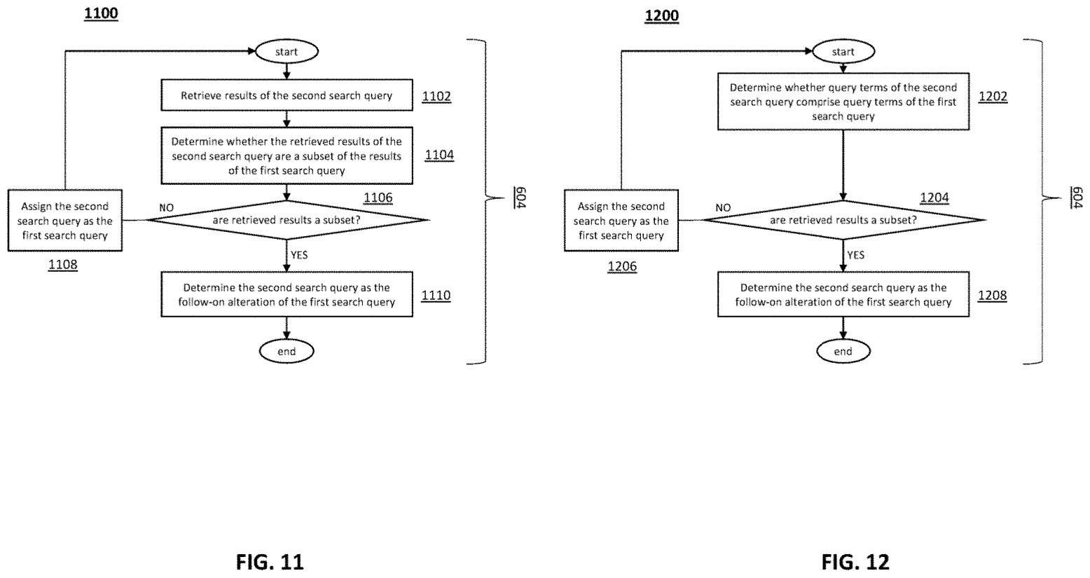

FIG. 11 is an illustrative flowchart of one embodiment of determining whether the second search query is a follow-on alteration of the first search query, in accordance with some embodiments of the disclosure. At 1102, the search engine server, by control circuitry 504, retrieves results of the second search query. The results of the second query may be stored in storage 511, or alternatively, in the query chain database 404.

At 1104, the search engine server, by control circuitry 504, determines whether the retrieved results of the second search query are a subset of the results of the first search query. In some embodiments, processing circuitry 508 may, in part or in whole, determine whether the retrieved results of the second search query are a subset of the results of the first search query. If, at 1106, control circuitry determines “No,” the retrieved results of the second search query are not a subset of the results of the first search query, the process advances to 1108. At 1108, the search engine server, by control circuitry 504, assigns the second search query as the first search query and the process reverts to “Start.” Consequently, the process may restart with the second search query now assigned as the first search query.

If, at 1106, control circuitry determines “Yes,” the retrieved results of the second search query are a subset of the results of the first search query, the process advances to 1110. At 1110, the search engine server, by control circuitry 504, determines the second search query as the follow-on alteration of the first search query.

FIG. 12 is an illustrative flowchart of another embodiment of determining whether the second search query is a follow-on alteration of the first search query, in accordance with some embodiments of the disclosure. At 1202, the search engine server, by control circuitry 504, determines whether query terms of the second search query include query terms of the first search query. In some embodiments, processing circuitry 508 may, in part or in whole, determine whether query terms of the second search query include query terms of the first search query. If, at 1204, control circuitry determines “No,” the query terms of the second search query do not include query terms of the first search query, the process advances to 1206. At 1206, the search engine server, by control circuitry 504, assigns the second search query as the first search query and the process reverts to “Start.” Consequently, the process may restart with the second search query now assigned as the first search query.

If, at 1204, control circuitry determines “Yes,” the query terms of the second search query include query terms of the first search query, the process advances to 1208. At 1208, the search engine server, by control circuitry 504, determines the second search query as the follow-on alteration of the first search query.

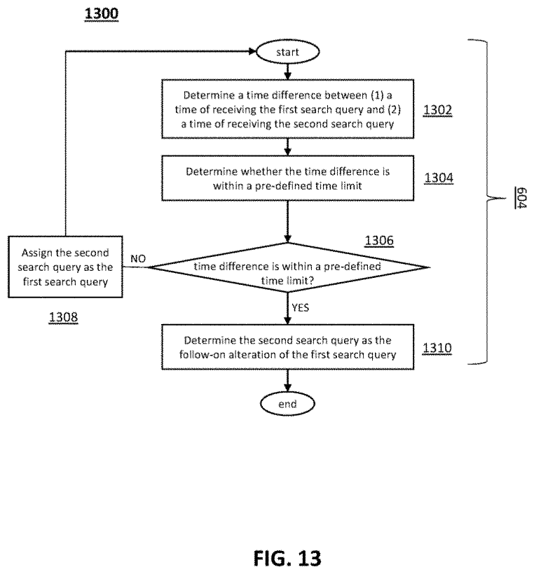

FIG. 13 is an illustrative flowchart of yet another embodiment of determining whether the second search query is a follow-on alteration of the first search query, in accordance with some embodiments of the disclosure. At 1302, the search engine server, by control circuitry 504, determines a time difference between a time of receiving the first search query and a time of receiving the second search query. In some embodiments, processing circuitry 508 may, in part or in whole, determine the time difference. The time of receiving the first and second queries may be retrieved from storage 511, the query chain database 404, and/or client devices 406, 408, or 410.

At 1304, the search engine server, by control circuitry 504, determines whether the time difference is within a predefined time limit. In some embodiments, processing circuitry 508 may, in part or in whole, determine whether the time difference is within a predefined time limit. In some embodiments, the predefined time limit may be pre-configured or provided to the search engine server. In other embodiments, the predefined time limit may be dynamically adjusted, by control circuitry 504, based on a statistical analysis of aggregate search query receipt times. If, at 1306, control circuitry determines “No,” the time difference is not within a predefined time limit, the process advances to 1308. At 1308, the search engine server, by control circuitry 504, assigns the second search query as the first search query and the process reverts to “Start.” Consequently, the process may restart with the second search query now assigned as the first search query.

If, at 1306, control circuitry determines “Yes,” the time difference is within a predefined time limit, the process advances to 1310. At 1310, the search engine server, by control circuitry 504, determines the second search query as the follow-on alteration of the first search query.

It is contemplated that the steps or descriptions of FIGS. 7-14 may be used with any other embodiment of this disclosure. In addition, the steps and descriptions described in relation to FIGS. 7-14 may be done in alternative orders or in parallel to further the purposes of this disclosure. For example, each of these steps may be performed in any order or in parallel or substantially simultaneously to reduce lag or increase the speed of the system or method. Any of these steps may also be skipped or omitted from the process. Furthermore, it should be noted that any of the devices or equipment discussed in relation to FIGS. 5-6 could be used to perform one or more of the steps in FIGS. 7-14.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method for providing anticipatory search results for a query, the method comprising:
receiving a first search query;
receiving a second search query, wherein the second search query is a follow-on alteration of the first search query;
searching a query chain database for a match for the first search query, wherein the query chain database associates queries that are part of a chain of queries comprising an original query and subsequent follow-on alterations of the query, and each chain of association terminates in a final follow-on alteration query;
in response to finding a match for the first search query, determining whether the second search query is associated by the query chain database as a follow-on alteration of the match for the first search query; and
in response to determining that the second search query is associated by the query chain database as the follow-on alteration of the match for the first search query:
retrieving the results of the final follow-on alteration query associated with the match for the first search query; and
responding to the second search query with the retrieved results instead of the results of the second search query.

2. The method of claim 1, wherein:
the first search query and the second search query each comprise one or more search terms;
each chain of queries in the query chain database comprises one or more search terms for each query associated by the chain;
searching the query chain database for a match for the first query comprises searching for a query within a chain of queries having one or more search terms matching the one or more search terms of the received first search query; and
determining whether the second search query is associated by the chain of queries comprises determining whether one or more search terms for a second query in the chain of queries matches the one or more search terms of the received second search query.

3. The method of claim 2, wherein searching for the query within the chain of queries having one or more matching search terms of the received first search query further comprises:
determining whether the one or more search terms of the query within the chain of queries and the one or more search terms of the first search query exceed a term similarity threshold; and
in response to the determination that the one or more search terms of the query within the chain of queries and the one or more search terms of the first search query exceed the term similarity threshold, identifying the query within the chain of queries exceeding the term similarity threshold as the match for the first search query.

4. The method of claim 2, wherein determining whether the second search query is associated by the chain of queries further comprises:
determining whether the one or more search terms of the second query within the chain of queries and the one or more search terms of the second search query exceed a term similarity threshold; and
in response to the determination that the one or more search terms of the second query within the chain of queries and the one or more search terms of the second search query exceed the term similarity threshold, identifying the second query within the chain of queries exceeding the term similarity threshold as the match for the second search query.

5. The method of claim 1, wherein:
the first search query and the second search query each comprise one or more search results;
each chain of queries in the query chain database comprises one or more search results for each query associated by the chain;
searching the query chain database for a match for the first query comprises searching for a query within a chain of queries having one or more search results matching the one or more search results of the received first search query; and
determining whether the second search query is associated by the chain of queries comprises determining whether one or more search results for a second query in the chain of queries matches the one or more search results of the received second search query.

6. The method of claim 5, wherein searching for a query within a chain of queries having one or more search results matching the one or more search results of the received first search query further comprises:
determining whether the one or more search results of the query within the chain of queries and the one or more search results of the first search query exceed a result similarity threshold; and
in response to a determination that the one or more search results of the query within the chain of queries and the one or more search results of the first search query exceed the result similarity threshold, identifying the query within the chain of queries exceeding the result similarity threshold as the match for the first search query.

7. The method of claim 5, wherein determining whether the second search query is associated by the chain of queries further comprises:
determining whether the one or more search results of the second query within the chain of queries and the one or more search results of the second search query exceed a result similarity threshold; and
in response to a determination that the one or more search results of the second query within the chain of queries and the one or more search results of the second search query exceed the result similarity threshold, identifying the second query within the chain of queries exceeding the result similarity threshold as the match for the second search query.

8. The method of claim 1, further comprising:
determining whether the second search query is a follow-on alteration of the first search query comprising:
retrieving results of the second search query;
determining whether the retrieved results of the second search query are a subset of the results of the first search query; and
in response to the determination that the retrieved results of the second search query are a subset of the results of the first search query, determining the second search query as the follow-on alteration of the first search query.

9. The method of claim 1, further comprising:
determining whether the second search query is a follow-on alteration of the first search query comprising:
determining whether query terms of the second search query comprise query terms of the first search query; and
in response to the determination that the query terms of the second search query comprise the query terms of the first search query, determining the second search query as the follow-on alteration of the first search query.

10. The method of claim 1, further comprising:
determining whether the second search query is a follow-on alteration of the first search query comprising:
determining a time difference between (1) a time of receiving the first search query and (2) a time of receiving the second search query;
determining whether the time difference is within a predefined time limit; and
in response to the determination that the time difference falls within the predefined time limit, determining the second search query as the follow-on alteration of the first search query.

11. A system for providing anticipatory search results for a query, comprising:
control circuitry configured to:
receive a first search query;
receive a second search query, wherein the second search query is a follow-on alteration of the first search query;
search a query chain database for a match for the first search query, wherein the query chain database associates queries that are part of a chain of queries comprising an original query and subsequent follow-on alterations of the query, and each chain of association terminates in a final follow-on alteration query;
in response to finding a match for the first search query, determine whether the second search query is associated by the query chain database as a follow-on alteration of the match for the first search query; and
in response to determining that the second search query is associated by the query chain database as the follow-on alteration of the match for the first search query:
retrieve the results of the final follow-on alteration query associated with the match for the first search query; and
respond to the second search query with the retrieved results instead of the results of the second search query.

12. The system of claim 11, wherein the control circuitry is further configured to:
the first search query and the second search query each comprise one or more search terms;
each chain of queries in the query chain database comprises one or more search terms for each query associated by the chain;
search the query chain database for a match for the first query comprises searching for a query within a chain of queries having one or more search terms matching the one or more search terms of the received first search query; and
determine whether the second search query is associated by the chain of queries comprises determining whether one or more search terms for a second query in the chain of queries matches the one or more search terms of the received second search query.

13. The system of claim 12, wherein control circuitry is further configured to, when searching for the query within the chain of queries having one or more matching search terms of the received first search query, to:
determine whether the one or more search terms of the query within the chain of queries and the one or more search terms of the first search query exceed a term similarity threshold; and
in response to the determination that the one or more search terms of the query within the chain of queries and the one or more search terms of the first search query exceed the term similarity threshold, identify the query within the chain of queries exceeding the term similarity threshold as the match for the first search query.

14. The system of claim 12, wherein control circuitry is further configured to, when determining whether the second search query is associated by the chain of queries, to:
determine whether the one or more search terms of the second query within the chain of queries and the one or more search terms of the second search query exceed a term similarity threshold; and
in response to the determination that the one or more search terms of the second query within the chain of queries and the one or more search terms of the second search query exceed the term similarity threshold, identify the second query within the chain of queries exceeding the term similarity threshold as the match for the second search query.

15. The system of claim 11, wherein control circuitry is further configured to:
the first search query and the second search query each comprise one or more search results;
each chain of queries in the query chain database comprises one or more search results for each query associated by the chain;
search the query chain database for a match for the first query comprises searching for a query within a chain of queries having one or more search results matching the one or more search results of the received first search query; and
determine whether the second search query is associated by the chain of queries comprises determining whether one or more search results for a second query in the chain of queries matches the one or more search results of the received second search query.

16. The system of claim 15, wherein control circuitry is further configured to, when searching for a query within a chain of queries having one or more search results matching the one or more search results of the received first search query, to:
determine whether the one or more search results of the query within the chain of queries and the one or more search results of the first search query exceed a result similarity threshold; and
in response to a determination that the one or more search results of the query within the chain of queries and the one or more search results of the first search query exceed the result similarity threshold, identify the query within the chain of queries exceeding the result similarity threshold as the match for the first search query.

17. The system of claim 15, wherein control circuitry is further configured to, when determining whether the second search query is associated by the chain of queries, to:
determine whether the one or more search results of the second query within the chain of queries and the one or more search results of the second search query exceed a result similarity threshold; and
in response to a determination that the one or more search results of the second query within the chain of queries and the one or more search results of the second search query exceed the result similarity threshold, identify the second query within the chain of queries exceeding the result similarity threshold as the match for the second search query.

18. The system of claim 11, wherein the control circuitry is further configured to:
determine whether the second search query is a follow-on alteration of the first search query wherein the control circuitry if further configured to:
retrieve results of the second search query;
determine whether the retrieved results of the second search query are a subset of the results of the first search query; and
in response to the determination that the retrieved results of the second search query are a subset of the results of the first search query, determine the second search query as the follow-on alteration of the first search query.

19. The system of claim 11, wherein the control circuitry is further configured to:
determine whether the second search query is a follow-on alteration of the first search query wherein the control circuitry if further configured to:
determine whether query terms of the second search query comprise query terms of the first search query; and
in response to the determination that the query terms of the second search query comprise the query terms of the first search query, determine the second search query as the follow-on alteration of the first search query.

20. The system of claim 11, wherein the control circuitry is further configured to:
determine whether the second search query is a follow-on alteration of the first search query wherein the control circuitry if further configured to:
determine a time difference between (1) a time of receiving the first search query and (2) a time of receiving the second search query;
determine whether the time difference is within a predefined time limit; and
in response to the determination that the time difference falls within the predefined time limit, determine the second search query as the follow-on alteration of the first search query.

21.-50. (canceled)
